(19) United States
(12) Patent Application Publication
(10) Pub. No.: US 2012/0213540 A1
(43) Pub. Date: Aug. 23, 2012

(54) Image Forming Apparatus, Method, Software Program, And Carrier Medium

(75) Inventor: Masaaki Igarashi, Tokyo (JP)

(73) Assignee: RICOH COMPANY, LTD., Tokyo (JP)

(21) Appl. No.: 13/363,441

(22) Filed: Feb. 1, 2012

(30) Foreign Application Priority Data
Feb. 21, 2011 (JP) 2011-034433

(51) Int. Cl. G03G 15/20

(52) U.S. Cl. 399/69; 399/334

(57) ABSTRACT

An image forming apparatus includes a generator, image forming unit, fixing unit, fixing temperature setting unit, and heating control unit. The generator generates image drawing data including text and/or photo, page by page, from image data. The image forming unit forms a latent image based on image drawing data, and develops and transfers developed image onto a recording medium. The fixing unit includes a fixing device having a plurality of heaters, and a surface of the fixing device is segmented into a plurality of heating areas each corresponding to one of the plurality of heaters. The fixing temperature setting unit sets a control-target fixing temperature at each heating area by associating text and/or photo in image drawing data with each heating area. The heating control unit controls current supply to each heater to heat each heating area to the set control-target fixing temperature.

### CROSS-REFERENCE TO RELATED APPLICATION

This application claims priority to Japanese Patent Application No. 2011-034433, filed on Feb. 21, 2011 in the Japan Patent Office, which is incorporated by reference herein in its entirety.

### BACKGROUND

1. Technical Field

The present invention relates to an image forming apparatus, an image forming control method, a software program for execution of an image forming control method, and a carrier medium or storage medium storing the software program, and more particularly to an image forming control method to control a control-target fixing temperature in one page in view of image information, a software program for execution of an image forming control method, and a carrier medium or storage medium storing the software program.

2. Description of the Background Art

Image forming apparatuses employing electrophotography such as printers, multi-functional apparatuses, or the like include a fixing unit to fix a toner-developed image or toner image on a sheet. The fixing unit includes a heat roller heatable to a given fixing temperature by a heater, and a pressure roller disposed opposite the heat roller. The sheet transferred with the toner image is fed between the heat roller and pressure roller as the two rollers rotate, by which heat and pressure can be applied to the sheet to fix the toner image on the sheet.

Conventionally, the fixing temperature of the fixing unit is controlled in view of image data information, such as toner concentration, to enhance fixing performance and reduce power consumption.

JP-2005-156977-A discloses a fixing device having one heater lamp at the axial center of the heat roller (a center heater lamp) and another heater lamp at each end of the heat roller (end heater lamps). In such a configuration, when a sheet having a size smaller than the area of the roller heated by the center heater lamp passes through the fixing device, the end heater lamps can be shut off. Such configuration can prevent high-temperature offset due to a local temperature increase at the heat roller when the small-sized sheet is passing through, and can also prevent curling of the sheet while reducing power consumption.

However, in this configuration, the heaters are disposed at the axial center and ends of the heat roller, and the heating of heater is controlled only according to sheet size, without regard to image data density. Further, in such conventional configuration, the entire heat roller is controlled to a single fixing temperature.

### SUMMARY

In one aspect of the present invention, an image forming apparatus is devised. The image forming apparatus includes an image drawing data generator to generate image drawing data including text and/or photo information, page by page, from image data to be printed by the image forming apparatus; an image forming unit to form a latent image on a photoconductor based on the image drawing data, develop the latent image developed with a developer agent, and transfer the developed image onto a recording medium; a fixing unit to fix the developed image on the recording medium by applying heat to the recording medium, the fixing unit including a fixing device having a plurality of heaters, a surface of the fixing device being segmented into a plurality of heating areas each corresponding to a respective one of the plurality of heaters, each of the heating areas heatable to a given control-target fixing temperature independently settable for each of the heating areas; a fixing temperature setting unit to set the control-target fixing temperature independently at each of the heating areas of the fixing device by associating the text and/or photo information in the image drawing data, generated by the image drawing data generator with the position of each of the heating areas; and a heating control unit to control current supply to each of the heaters based on the control-target fixing temperature set at each of the heating areas by the fixing temperature setting unit, by which each of the heating areas is heated to the set control-target fixing temperature.

In another aspect of the present invention, a method of controlling image formation by an image forming apparatus is devised. The method includes the steps of generating image drawing data including text and/or photo information, page by page, from image data to be printed by the image forming apparatus; forming a latent image on a photoconductor based on the image drawing data; developing the latent image with a developer agent; transferring the developed image onto a recording medium; fixing the developed image on the recording medium by applying heat to the recording medium, using a fixing unit including a fixing device having a plurality of heaters, a surface of the fixing device being segmented into a plurality of heating areas each corresponding to a respective one of the plurality of heaters, each of the heating areas heatable to a given control-target fixing temperature independently settable for each of the heating areas; setting the control-target fixing temperature independently at each of the heating areas of the fixing device by associating the text and photo information in the image drawing data generated at the generating step with the position of each of the heating areas; and controlling current supply to each of the heating areas of the heater based on the control-target fixing temperature set at each of the heating areas by the setting step, by which each of the heating areas is heated to the set control-target fixing temperature.

In another aspect of the present invention, a non-transitory computer readable carrier medium storing a program for executing a method of controlling image formation by an image forming apparatus, which when executed causes a computer to perform the method of controlling image formation, is devised. The method includes the steps of generating image drawing data including text and/or photo information, page by page, from image data to be printed by the image forming apparatus; forming a latent image on a photoconductor based on the image drawing data; developing the latent image with a developer agent; transferring the developed image onto a recording medium; fixing the developed image on the recording medium by applying heat to the recording medium, using a fixing unit including a fixing device having a plurality of heaters, a surface of the fixing device being segmented into a plurality of heating areas each corresponding to a respective one of the plurality of heaters, each of the heating areas heatable to a given control-target fixing temperature independently settable for each of the heating areas; setting the control-target fixing temperature independently at each of the heating areas of the fixing device by associating the text and photo information in the image drawing data generated at the generating step with the position of each of the heating areas; and controlling current supply to each of the heating areas of the heater based on the control-target fixing temperature set at each of the heating areas by the setting step, by which each of the heating areas is heated to the set control-target fixing temperature.

### BRIEF DESCRIPTION I/F THE DRAWINGS

A more complete appreciation of the disclosure and many of the attendant advantages and features thereof can be readily obtained and understood from the following detailed description with reference to the accompanying drawings, wherein:

FIG. 1 is a block diagram of an image forming apparatus according to an example embodiment;

FIG. 2 is a front cross-sectional view of a heat roller according to an example embodiment;

FIG. 3 is a functional block diagram of a controller;

FIG. 4 is a functional block diagram of an image analysis function unit;

FIG. 5 is a flowchart of steps in a fixing temperature control process conduct-able in view of each heating area of a heat roller;

FIG. 6 is an example temperature database for text area;

FIG. 7 is an example temperature database for photo area;

FIG. 8 is an example image pattern and corresponding heating areas; and

FIG. 9 is an example of a correlation between heating areas of a heat roller and image areas on a sheet.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION I/F EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, an apparatus or system, according to an example embodiment is described hereinafter.

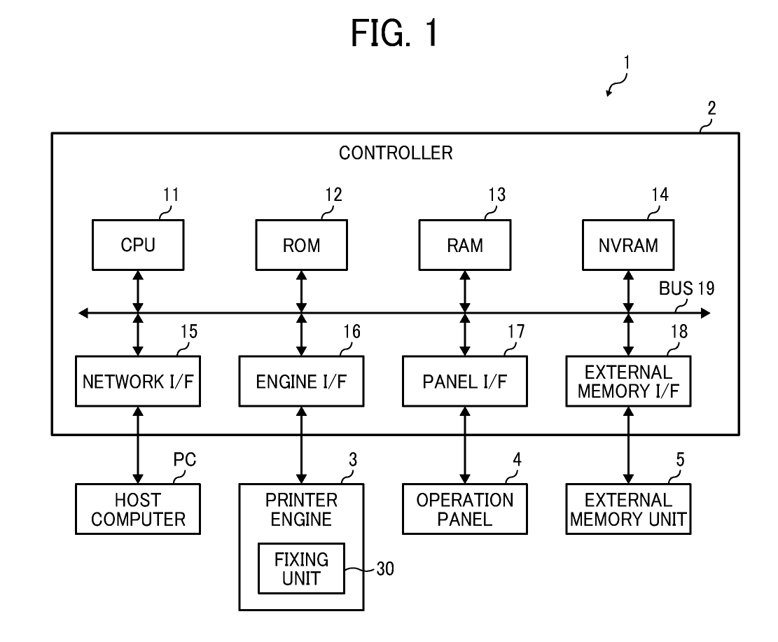

FIGS. 1 to 9 show an image forming apparatus, an image forming control method, a software program of image forming control method, and a carrier medium or storage medium according to an example embodiment. The carrier medium may be also referred to the storage medium. FIG. 1 is a block diagram of an image forming apparatus 1, which employs an image forming apparatus, an image forming control method, a software program of image forming control method and a carrier medium or storage medium according to an example embodiment.

As shown in FIG. 1, the image forming apparatus 1 includes a controller 2, a printer engine 3, and an operation panel or control panel 4, and an external storage 5. The controller 2, which may be a processor, includes a central processing unit (CPU) 11, a read only memory (ROM) 12, a random access memory (RAM) 13, a nonvolatile random access memory (NVRAM) 14, a network interface (I/F) 15, an engine interface (I/F) 16, and a panel interface (I/F) 17, and an external storage interface (I/F) 18, wherein such units can be connected with each other using a bus 19.

The engine I/F 16 can be connected to the printer engine 3. The engine I/F 16 is used to transmit control signals and image drawing data from the controller 2 to the printer engine 3, and to transmit status signals from the printer engine 3 to the controller 2. For example, the engine I/F 16 can be used to transmit the total number of print pages of one print job from the CPU 11 to the printer engine 3.

The printer engine 3, used as an image forming unit, for example, can be used as an engine for electrophotography. The printer engine 3 includes a fixing unit 30. At first, print data is transmitted from the host computer Pc to the network I/F 15, and is converted to image drawing data, and then the image drawing data is received by the printer engine 3 via the engine I/F 16. The printer engine 3 prints an image on a sheet, fed from a sheet feeder (i.e., outputting of image), and ejects the printed sheet to an ejection tray through a sheet ejection port after fixing the image on the sheet using the fixing unit 30.

When the printer engine 3 is used as an electro-photographic engine, the printer engine 3 includes a photoconductor, an optical writing unit, a developing unit, a charging unit, and a cleaning unit, and the fixing unit 30, which may be required for electrophotography to conduct a printing process on a sheet based on image drawing data. A latent image can be formed on the photoconductor using the optical writing unit based on image drawing data and control signals, and then a toner image can be formed on the photoconductor by supplying toner onto the latent image using the developing unit. Under the control of the printer engine 3, a sheet is fed between the photoconductor and a transfer unit from a sheet feeder, and then the toner image is transferred from the photoconductor to the sheet. The sheet having the transferred toner image is then transported to the fixing unit 30 to fix the toner image on the sheet by applying pressure and heat, by which a printing process is completed.

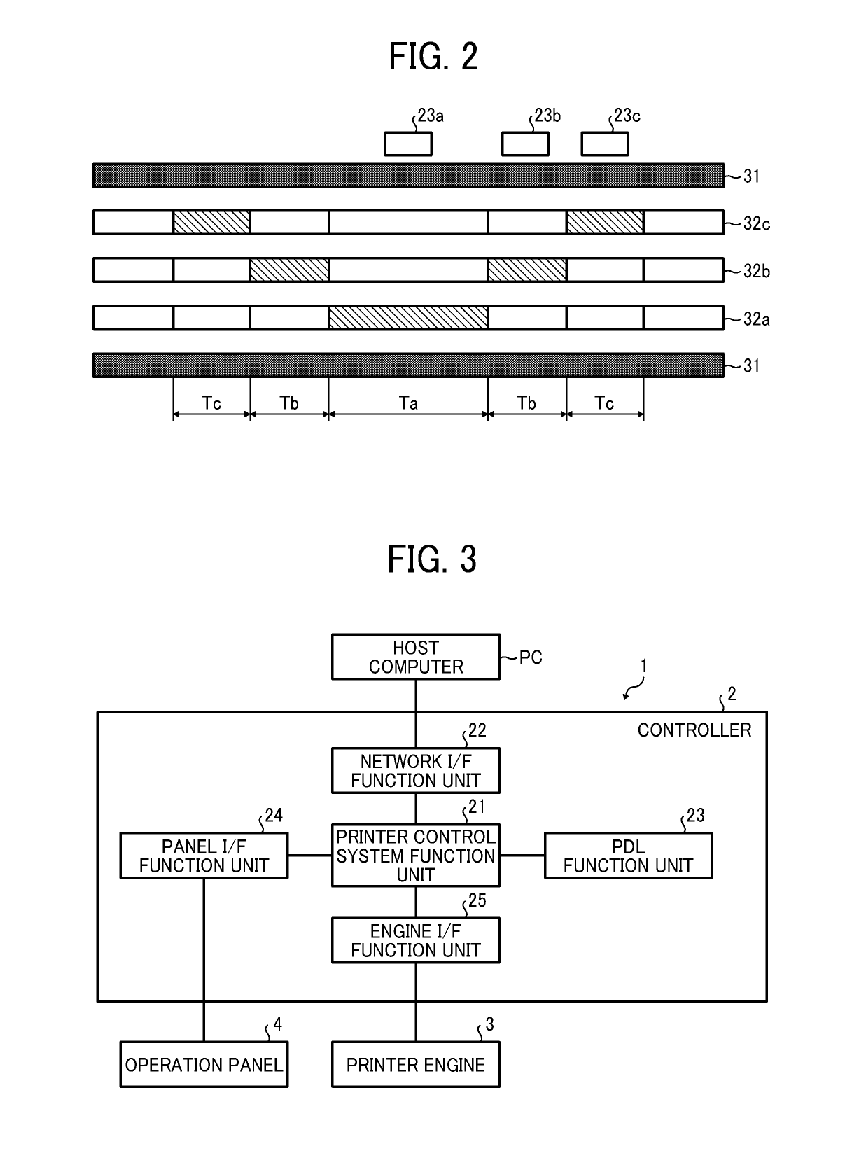

As shown in FIG. 2, the fixing unit 30 includes a heat roller 31 used as a fixing device, and the heat roller 31 includes a plurality of heaters such as heater lamps 32a, 32b, and 32c in the heat roller 31. As such, the heat roller 31 may include a plurality of heating elements such as lamps extending in the axis direction of the heat roller 31, wherein FIG. 2 shows a case that three heater lamps are used but the numbers of heating elements is not limited to three, but two, three, four elements, and so on, can be set in view of design of apparatuses. Each of the heater lamps 32a, 32b, and 32c can heat different portions of the heat roller 31 along the axis direction of the heat roller 31. Specifically, the heater lamps 32a, 32b, and 32c may heat heating areas Ta, Tb, and Tc, respectively as shown in FIG. 2.

In such a configuration, if all of the heater lamps 32a, 32b, and 32c are activated, all of the heating areas Ta, Tb, and Tc can be heated, by which the entire area of the heat roller 31 along the axis direction of the heat roller 31 can be heated.

Further, if one or some of the heater lamps 32a, 32b, and 32c are activated (i.e., not activating all of the heater lamps), the heat roller 31 can be partially heated (partial heating). For example, the heater lamp 32a can heat the heating area Ta, which is a given portion around the center of the heat roller 31 in the axis direction of the heat roller 31. The heater lamp 32b can heat the heating area Tb, which is a given portion next to the heating area Ta and extending for some distance in the axis direction of the heat roller 31. The heater lamp 32c can heat the heating area Tc, which is a given portion next to the heating area Tb in the axis direction of the heat roller 31 and extending toward the end of the heat roller 31.

Further, as shown in FIG. 2, the fixing unit 30 may include temperature sensor 23a, 23b, and 23c to detect the temperature at the heating areas Ta, Tb, and Tc, respectively. Each of the temperature sensor 23a, 23b, and 23c outputs detection signals to the CPU 11 via the engine I/F 16 of the controller 2. To be described later, the CPU 11 controls the current supply to the heater lamps 32a, 32b, and 32c based on the detection signals received from the temperature sensor 23a, 23b, and 23c to control the temperature at the heating areas Ta, Tb, and Tc at a control-target fixing temperature.

The ROM 12 stores various types of software programs used for data processing/management and for controlling peripheral modules, and various types of data to execute each one of software programs. Specifically, the ROM 12 stores one or more software programs for basic processing in the image forming apparatus 1, and one or more software programs to execute an image forming control method such as a software program of image forming control program to conduct an image forming control method which can enhance the fixing performance and the power saving performance. As described later, the power supply to the heater lamps 32a, 32b, and 32c of the fixing unit 30 in the printer engine 3 can be controlled based on image data and/or various types of data to execute a software program according to an example embodiment.

The CPU 11 can execute software programs stored in the ROM 12 while using the RAM 13 as a working memory. Specifically, the CPU 11 controls each unit in the image forming apparatus 1 to conduct a printing process, and controls an image forming process, which will be described later.

The RAM 13 can be used as a working memory of the CPU 11, and as a buffer to temporarily store page-by-page data converted from print data transmitted from the host computer Pc, and a bitmap memory to store image drawing data (i.e., actual print data) converted from data stored in the buffer. The RAM 13 has a capacity to store the print data, the image drawing data converted from the print data, or intermediary data for a plurality of pages.

The NVRAM 14 is a memory to store data even when the power supply to the image forming apparatus 1 is shut-off. The NVRAM 14 can store data that needs to be retained even if power supply to the image forming apparatus 1 is shut-off. For example, under the control of the CPU 11, the NVRAM 14 stores various setting information such as system setting values, count values of printed sheets, print setting values, and various types of data and setting information used for controlling the current supply to the heater lamps 32a, 32b, and 32c used for an image forming process based on information of image data, which will be described later.

The panel I/F 17 can be connected to the control panel 4. The panel I/F 17 can be used to transmit signals between the controller 2 and the control panel 4. The control panel 4 may be referred to as the operation panel 4.

The control panel 4 may include operation keys such as ten keys, a start key, mode keys to select modes, and a display such as a touch panel display using a liquid crystal display (LCD). By operating the operation keys and touching the display, various instructions such as print instruction can be input, and the display displays instructions input from the operation keys, and other information of the image forming apparatus 1 to report information and status to a user.

The external storage I/F 18 can be connected to the external storage 5 such as a hard disk, a universal serial bus (USB) memory, or the like. Under the control of the CPU 11, the external storage 5 stores the prepared print data, and data transmitted from the host computer Pc (e.g., print data). Such data can be read out from the external storage 5 at a given timing as required.

The network I/F 15 can be connected to a host computer Pc via a network such as a local area network (LAN) or the like. The network I/F 15 receives control signals and data (e.g., print data) from the host computer Pc, and transmits status signals or the like from the image forming apparatus 1 to the host computer Pc. As such, the network I/F 15 can be used as an interface.

The host computer Pc may be a personal computer having a hardware configuration or a hardware/software-combined configuration. The host computer Pc transmits print data prepared by page description language (PDL) and control command such as print control data prepared by printer job language (PJL) to the image forming apparatus 1.

The host computer Pc may use a printer driver to generate or prepare print data composed of PJL data and PDL data, and transmits the print data to the image forming apparatus 1 via a network.

As for the image forming apparatus 1, a software program to implement an image forming control can be loaded to the ROM 12, with which the fixing temperature at a plurality of areas in one page can be controlled based on print data, which will be described later. Such image forming control program is executed to conduct the image forming control method for the image forming apparatus 1 according an example embodiment.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a Wireless Application Protocol (WAP) or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a flexible disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, work station) may control an information processing apparatus or an image processing apparatus such as image forming apparatus using a computer-readable program, which can execute the above-described processes or steps. In the above described embodiments, at least one or more of the units of apparatus can be implemented in hardware or as a combination of hardware/software combination. In example embodiments, processing units, computing units, or controllers can be configured with using various types of processors, circuits, or the like such as a programmed processor, a circuit, an application specific integrated circuit (ASIC), used singly or in combination.

When a program for implementing the image forming control according to an example embodiment is loaded and executed in the image forming apparatus 1, the controller 2 can be configured with functional units shown in FIG. 3. For example, the controller 2 is configured with a printer control system function unit 21, a network interface (I/F) function unit 22, an image analysis function unit 23, a panel interface (I/F) function unit 24, and an engine interface (I/F) function unit 25. The image analysis function unit 23 may be referred to as the PDL/PJL function unit 23.

The network I/F function unit 22 receives control signals and data (e.g., print data) from the host computer Pc, and then transmits the signals and data to the printer control system function unit 21. Further, the network I/F function unit 22 receives status signals from the printer control system function unit 21 of the image forming apparatus 1 and then transmits the status signals to the host computer Pc.

The image analysis function unit 23 which is referred to as PDL function unit 23 in FIG. 3 and used as an image processing unit, receives print data and generates or prepares image drawing data, and stores the image drawing data to the RAM 13. As such, the image analysis function unit 23 can be used as a generator of image drawing data (image drawing data generator). Specifically, the image analysis function unit 23 interprets PJL command and PDL command in the print data transmitted from the host computer Pc to generate or prepare image drawing data, and stores the image drawing data to the RAM 13. Then, the image analysis function unit 23 transfers the image drawing data to the printer control system function unit 21.

Under the control of the printer control system function unit 21, the panel I/F function unit 24 controls the control panel 4.

Under the control of the printer control system function unit 21, the engine I/F function unit 25 issues a print instruction or other instructions to the printer engine 3. For example, the engine I/F function unit 25 is used when to control the current supply for the heater lamps 32a, 32b, and 32c of the fixing unit 30.

The printer control system function unit 21 controls each unit in the image forming apparatus 1, and operations of the printer engine 3. For example, the printer control system function unit 21 can be used to control the fixing temperature of the fixing unit 30 of the printer engine 3. As such, the printer control system function unit 21 can be used as a fixing temperature control unit.

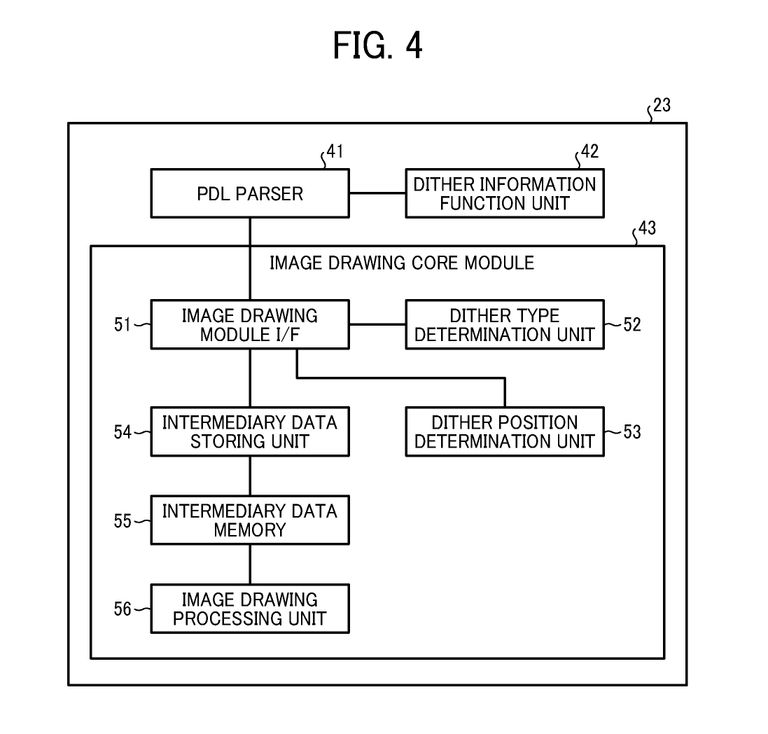

As shown in FIG. 4, the image analysis function unit 23 can be configured with a plurality of functional units. For example, the image analysis function unit 23 includes a PDL parser 41, a dither information function unit 42, and an image drawing core module 43. The image drawing core module 43 includes an image drawing module interface (I/F) 51, a dither type determination unit 52, a dither position determination unit 53, an intermediary data storing unit 54, an intermediary data memory 55, and an image drawing processing unit 56.

The PDL parser 41 conducts syntactic analysis of print data for each of PDL such as printer control language (PCL), postscript (PS), or the like by referring dither information of the dither information function unit 42, and outputs an analysis result to the image drawing core module 43.

The image drawing core module 43 receives the analysis result from the PDL parser 41 using the image drawing module I/F 51, which is an interface for receiving data such as text, image, vector graphics, image drawing setting information or the like. Then, the analysis result is transferred to the dither type determination unit 52 and the dither position determination unit 53.

Further, image drawing data such as text, image, vector graphics, and image drawing setting information such as color and transparent level are transferred to the intermediary data storing unit 54, and the intermediary data storing unit 54 stores such data to the intermediary data memory 55.

The dither information used by the image drawing core module 43 can be provided to the image drawing core module 43 by obtaining the dither information from the ROM 12 or the like using the PDL parser 41 when activating the unit or apparatus.

The image drawing processing unit 56 may be configured with a plurality of units, and conducts rendering for the outputting image data based on the image drawing data.

The dither type determination unit 52 receives the analysis result and print data from the PDL parser 41 via the image drawing module I/F 51. Based on the analysis result, the resolution level and depth of page data, and other settings, the dither type determination unit 52 selects a dither identification (ID) used for each page based on the dither information received from the PDL parser 41.

The dither position determination unit 53 determines what kind of dither is used at which drawing area of image drawing data based on the dither position information used for data processing.

As for the image forming apparatus 1 (e.g., digital copier), the surface of the heat roller 31 of the fixing unit 30 is segmented to a plurality of heating areas, and the control-target fixing temperature at each one of the heating areas is controlled based on image information of print data such as dither information or dither distribution information.

As for the image forming apparatus 1, upon receiving print data from the host computer Pc via the network I/F 15, the CPU 11 loads and executes a given software program, stored in the ROM 12, and prepares image drawing data page-by-page from the print data using the RAM 13 as a working memory. The CPU 11 transfers the prepared image drawing data to the printer engine 3 via the engine I/F 16. Then, the printer engine 3 prints out an image on a sheet.

The CPU 11 controls the heating condition of the heat roller 31 of the fixing unit 30 in view of the prepared page-by-page image drawing data using image information included in the image drawing data, wherein the heat roller 31 can be heated partially in some cases. As such, the CPU 11 can function as a heating control unit to control heating condition of the heat roller 31.

When the image forming control program according to an example embodiment is executed, the printer control system function unit 21 can be configured in the controller 2. When the printer control system function unit 21 receives print data transmitted from the host computer Pc via the network I/F function unit 22, the image analysis function unit 23 analyzes image information such as dither information of each page in view of each of the heating areas Ta, Tb, and Tc of the heat roller 31. Based on such image information, the control-target fixing temperature at each of the heating areas Ta, Tb, and Tc can be set, and the current supply to the heater lamps 32a, 32b, and 32c can be controlled, by which the fixing process can be controlled.

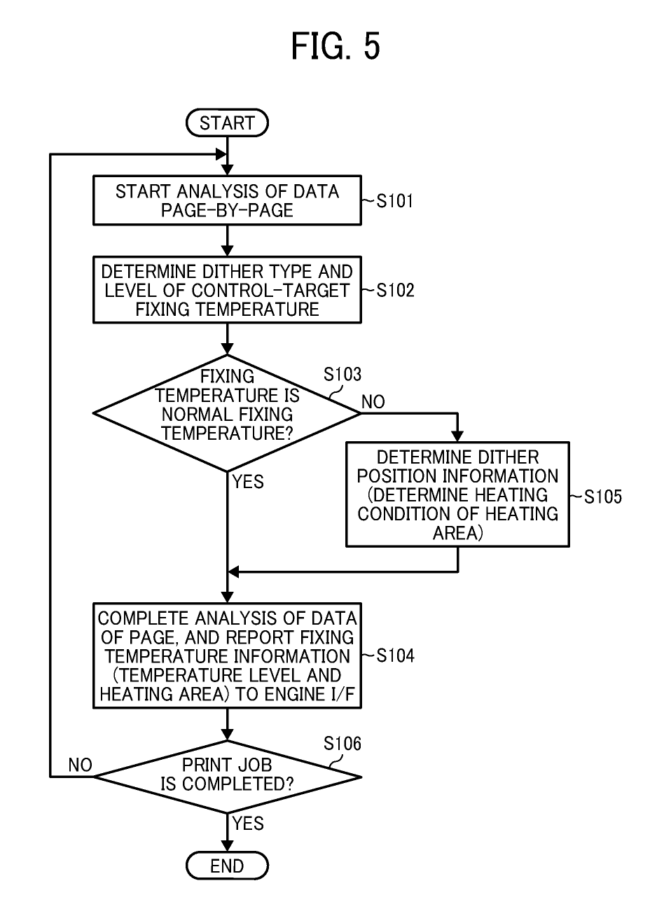

As shown in FIG. 5, when the image analysis function unit 23 starts an analysis of image drawing data page-by-page (step S101), dither types for each one of pages of the image drawing data is determined (step S102). Specifically, by determining the dither types such as text, graphics, image of one page of image drawing data corresponding to each of the heating areas Ta, Tb, and Tc (see FIG. 2), the level of the control-target fixing temperature at each of the heating areas Ta, Tb, and Tc can be determined at step S102.

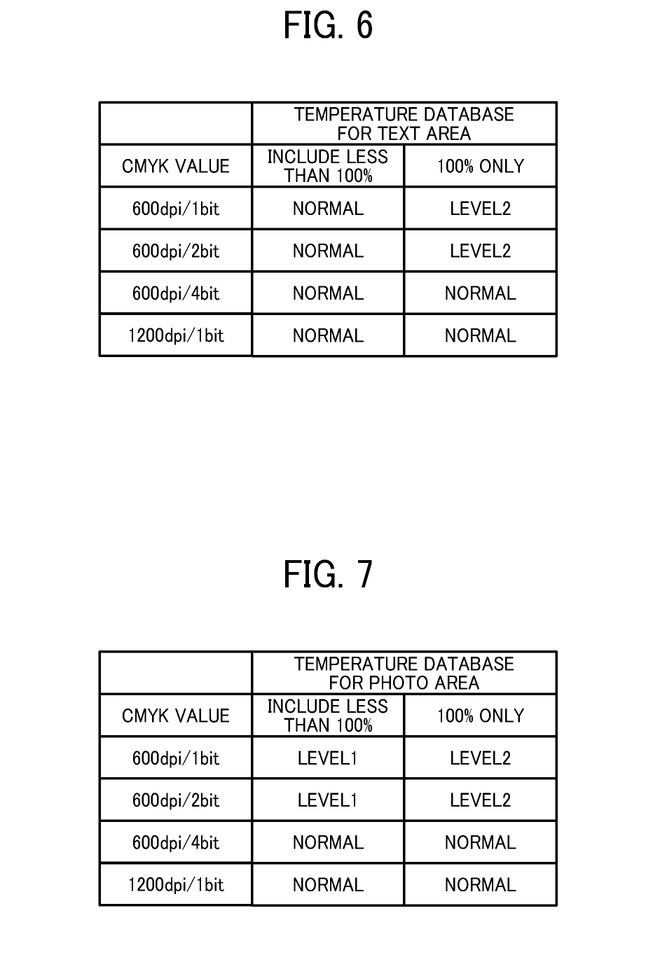

For example, the ROM 12 or the NVRAM 14 may store a temperature database or control-target fixing temperature table shown in FIGS. 6 and 7, in which the control-target fixing temperature can be set in view of types of image information. Specifically, the control-target fixing temperature can be set at a normal fixing temperature (Normal), a first low fixing temperature (Level 1), and a second low fixing temperature (Level 2).

The first low fixing temperature (Level 1) may be set at a given temperature lower than the normal fixing temperature. For example, the first low fixing temperature may be set lower than the normal fixing temperature by three (3) degrees. Similarly, the second low fixing temperature (Level 2) may be set at a given temperature lower than the first low fixing temperature. For example, the second low fixing temperature may be set lower than the first fixing temperature by five (5) degrees, which means the second low fixing temperature is set lower than the normal fixing temperature by eight (8) degrees.

Because the dither pattern used for text area and the dither pattern used for photo area are different patterns, the temperature database may be prepared separately for text area where text is present (see FIG. 6), and for photo area where photo image is present (see FIG. 7). As such, the fixing temperature can be set differently or independently for the text area and photo area.

Because the preferable fixing temperature is effected by factors such as image resolution level, bit depth, cyan/magenta/yellow/black (CMYK) value (so called image concentration such as from 0% to 100%), when the temperature databases shown in FIGS. 6 and 7 are prepared separately for the text area and the photo area, the effect of actual text percentage in the text area, the effect of actual photo percentage in the photo area, and the effect of CMYK value may be incorporated when setting the control-target fixing temperature.

The image analysis function unit 23 checks whether the control-target fixing temperature at each of the heating areas Ta, Tb, and Tc is the normal fixing temperature (step S103). If the control-target fixing temperature is the normal fixing temperature, it is determined that no change is required for temperature setting (step S103: Yes), and the image analysis function unit 23 reports the normal fixing temperature to the fixing unit 30 of the printer engine 3 (step S104).

In contrast, if the control-target fixing temperature is not the normal fixing temperature but the control-target fixing temperature is the first low fixing temperature or the second low fixing temperature (step S103: No), the heating condition of the heating areas Ta, Tb, and Tc is determined based on the dither information corresponding to each of the heating areas Ta, Tb, and Tc (step S105).

Then, the image analysis function unit 23 reports the first low fixing temperature or the second low fixing temperature to the fixing unit 30 of the printer engine 3 (step S104), which is set as the control-target fixing temperature for each of the heating areas Ta, Tb, and Tc.

After completing the determination and setting of the control-target fixing temperature for each of the heating areas Ta, Tb, and Tc, the image analysis function unit 23 checks whether a print job is completed, which means that the image analysis function unit 23 checks whether the printing of all pages has completed (step S106). If the print job has not yet completed (step S106: No), the process returns to step S101, and then steps S101 to S106 are repeated. If the print job has completed (step S106: Yes), the image analysis function unit 23 ends the fixing temperature control process.

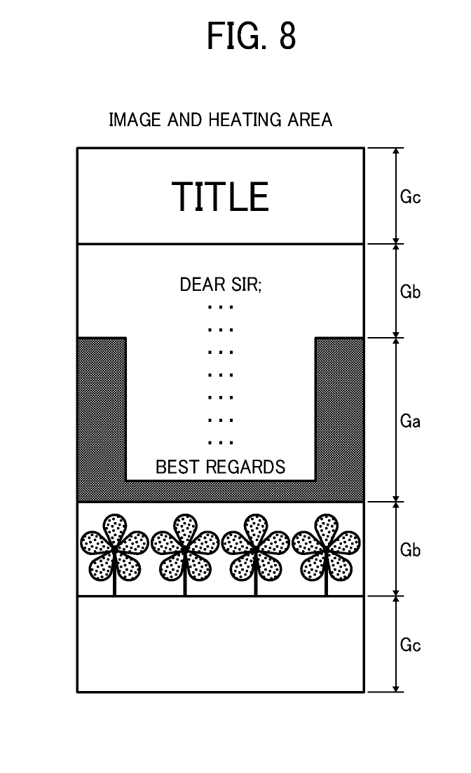

FIG. 8 shows an example image pattern of one page to be printed by the printer engine 3. When one page of image drawing data is to be printed by the printer engine 3, the fixing unit 30 fixes a toner image of one page on a recording medium such as a sheet. In an example case of FIG. 8, the image drawing data can be divided into image areas Ga, Gb, and Gc, in which each of image areas Ga, Gb, and Gc is corresponded to the heating areas Ta, Tb, and Tc. In this example image pattern, only text such as characters is present in the image area Ga as main text portion in one page, text such as characters and picture such as photo image are present in the image area Gb, and only text such as “title” is present in the image area Gc.

In general, text such as characters can be fixed at a low temperature, which means relatively good fixing performance, while picture images such as photos can only be fixed at a high temperature, which means relatively poor fixing performance.

Therefore, as for the example image pattern shown in FIG. 8, the image analysis function unit 23 may set the first low fixing temperature or the second low fixing temperature for the heating areas Ta and Tc, corresponding to the image areas Ga and Gc including only text such as characters. Further, the image analysis function unit 23 may set the normal fixing temperature for the heating area Tb, corresponding to the image area Gb including picture images because the picture images need a high fixing temperature for the fixing process. As such, the image analysis function unit 23 may be used as a fixing temperature setting unit to set the control-target fixing temperature.

Based on the control-target fixing temperature set by the above described process, the fixing unit 30 can fix toner image transferred onto a sheet.

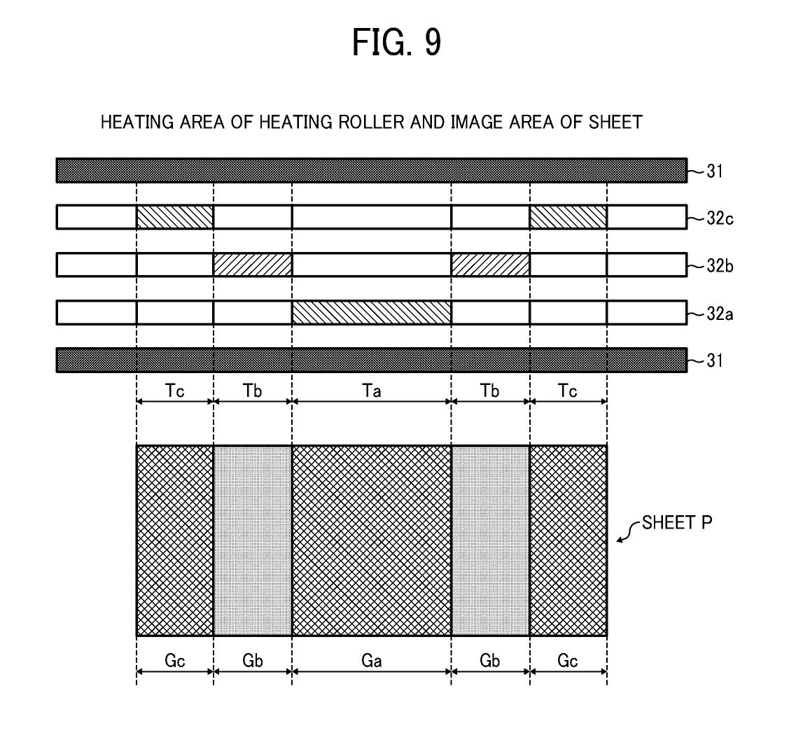

FIG. 9 shows a correlation between heating areas and image areas. Specifically, the toner image can be fixed on a sheet P using the fixing unit 30 as follows: the heating areas Ta and Tc of the heat roller 31 can be heated to the first low fixing temperature or the second low fixing temperature by using the heater lamp 32a and the heater lamp 32c. Such heated heating areas Ta and Tc respectively heat the image area Ga and the image area Gc to fix the toner image on the sheet P. Further, the heating area Tb of the heat roller 31 can be heated to the normal fixing temperature by using the heater lamp 32b. Such heated heating area Tb heats the image area Gb to fix the toner image on the sheet P.

In the image forming apparatus 1, the image analysis function unit 23 of the controller 2 prepares or generates image drawing data including text, photo or the like from to-be-printed image data, page-by-page, and then a latent image formed on a photoconductor based on the image drawing data. The latent image is developed as a toner-developed image by using a developer agent such as toner, and then the toner image is transferred to a recording medium such as a sheet P.

The outer face of the heat roller 31 (fixing device) is segmented to a plurality of heating areas Ta, Tb, and Tc. Each of the heating areas Ta, Tb, and Tc of the heat roller 31 can be heated by using the heater lamps 32a, 32b, and 32c (heaters). Each of the heating areas Ta, Tb, and Tc is heated to a given control-target fixing temperature, which may be separately or independently set for the heating areas Ta, Tb, and Tc. Then, the toner image is fixed on the sheet P using the heat roller 31 having such heating areas Ta, Tb, and Tc.

When fixing the toner image on the sheet P, the position of image information such as text, photo image or the like of the image drawing data and the position of the heating areas Ta, Tb, and Tc are considered. For example, it is determined what kind of image information (e.g., text, photo) is corresponded to each of the heating areas Ta, Tb, and Tc. Based on the types of image information at each of the heating areas Ta, Tb, and Tc, the control-target fixing temperature can be selectively set for each of the heating areas Ta, Tb, and Tc. Then, based on the control-target fixing temperature set for each of the heating areas Ta, Tb, and Tc, the current supply to the heater lamps 32a, 32b, and 32c can be controlled, by which each of the heating areas Ta, Tb, and Tc can be heated at the control-target fixing temperature, which may be separately or independently set for the heating areas Ta, Tb, and Tc.

As such, the surface of the heat roller 31, which is used to heat the sheet P transferred with the toner image, can be segmented into the heating areas Ta, Tb, and Tc. The control-target fixing temperature at each of the heating areas Ta, Tb, and Tc can be set separately or independently for each of the heating areas Ta, Tb, and Tc based on information included in the image drawing data to be developed as the toner image. The sheet P transferred with the toner image can be heated using such configured heat roller 31. With such a configuration, the fixing performance can be enhanced while the power saving effect can be enhanced.

As for the image forming apparatus 1, the surface of the heat roller 31 can be segmented into a plurality of heating areas Ta, Tb, and Tc in the axis direction of the heat roller 31, wherein the each of the heating areas Ta, Tb, and Tc corresponds to each of the heater lamps 32a, 32b, and 32c, and thereby each of the heating areas Ta, Tb, and Tc can be heated to a given control-target fixing temperature set separately or independently.

As such, because the surface of the heat roller 31 is segmented for a plurality of heating areas in the axis direction of the heat roller 31 or main scanning direction of image forming, the heat roller 31 can effectively heat image area of the sheet P. With such a configuration, the control-target fixing temperature can be preferably set for the heat roller 31 in view of image information such as text and photo included in the image drawing data when conducting the fixing process. With such a configuration, the fixing performance can be enhanced while the power saving effect can be enhanced.

Further, the surface of the heat roller 31 can be segmented into a plurality of heating areas in a direction perpendicular to the axis direction of the heat roller 31 by setting a plurality of heaters such as heater lamps, in which each of the heating areas can be heated to the control-target fixing temperature separately or independently. In such a configuration, the heating areas of the heat roller 31 can be segmented into the sub-scanning direction of image forming, which is the direction perpendicular to the axis direction of the heat roller 31 or main scanning direction of image forming.

Further, the surface of the heat roller 31 can be segmented into a plurality of heating areas in the axis direction of the heat roller 31 or main scanning direction of image forming and the direction perpendicular to the axis direction of the heat roller 31 or sub-scanning direction of image forming by setting a plurality of heat devices or heaters such as heater lamps in the axis direction and the direction perpendicular to the axis direction, in which each of the heating areas can be heated to the control-target fixing temperature separately or independently and further effectively.

With such a configuration, the control-target fixing temperature can be further preferably set for each of heating areas of the heat roller 31 in view of image information such as text and photo included in the image drawing data when conducting the fixing process on the sheet P. Specifically, based on the position of image information such as text and photo of image drawing data on the sheet P, a given control-target fixing temperature, corresponding to the position of image information such as text and photo of image drawing data, can be set. With such a configuration, the fixing performance can be enhanced while the power saving effect can be enhanced.

Further, as for the image forming apparatus 1, the image analysis function unit 23 can correctly correlate the image areas Ga, Gb, and Gc and the heating areas Ta, Tb, and Tc on the heat roller 31. In general, image areas Ga, Gb, and Gc are logical positions defined by PDL data while the heating areas Ta, Tb, and Tc are physical positions, wherein the physical positions of heating areas Ta, Tb, and Tc corresponds to physical positions on a recording medium such as sheet. Such logical positions and physical positions may not correctly correspond with each other, and thereby a mapping process to correctly correlate the logical positions and physical positions may be required.

The logical positions of image areas Ga, Gb, and Gc can be expressed by (x, y) such as (x1, y1), (x2, y2), . . . (xn, yn) while the physical positions of heating areas Ta, Tb, and Tc can be expressed by (X, Y) such as (X1, Y1), (X2, Y2), . . . (Xn, Yn). Before setting the control-target fixing temperature for the heating areas Ta, Tb, and Tc, the relative positions of the logical positions of image areas Ga, Gb, and Gc and the physical positions of heating areas Ta, Tb, and Tc can be computed based on the coordinate data of image data in the image drawing data, wherein the coordinate data of image data can define the logical positions of image areas Ga, Gb, and Gc. If the logical positions of image areas Ga, Gb, and Gc and the physical positions of heating areas Ta, Tb, and Tc are not correctly correlated, the logical positions of image areas Ga, Gb, and Gc and the physical positions of heating areas Ta, Tb, and Tc can be adjusted to the correct positional relationship, in which the logical positions of image areas Ga, Gb, and Gc may be adjusted in view of the margin area of the heating areas Ta, Tb, and Tc such as top/bottom margin and/or left/right margin of sheet. As such, it can be determined which image data correspond to which image area, and each heating area Ta, Tb, and Tc of the heat roller 31 can be corresponded to the image areas Ga, Gb, and Gc. Therefore, the relative positions of the image areas Ga, Gb, and Gc and the heating areas Ta, Tb, and Tc can be determined effectively and easily based on the coordinate data of image data in the image drawing data.

Further, as for the image forming apparatus 1, the image analysis function unit 23 can use the temperature database, which sets the control-target fixing temperature (see control-target fixing temperature table of FIGS. 6 and 7) for each of image information such as text and/or photo, which is set in advance. The image analysis function unit 23 can set the control-target fixing temperature corresponding to image information such as text and/or photo included in the image drawing data by referring the temperature database.

Therefore, preferable control-target fixing temperature matched to image information such as text, photo, or the like included in the image drawing data can be set quickly, and thereby the processing performance such as processing speed can be enhanced while enhancing the fixing performance and the power saving effect. It should be noted that image information is not limited to text and photo.

As above described, the temperature distribution on the surface of the fixing device can be controlled in view of image information distribution in one page while enhancing the fixing performance and the power saving effect performance, in which the surface temperature of the fixing device can be controlled in view of types of image information included in image data of one page. Such fixing device can be applied to an image forming apparatus, an image forming control method, an image forming control program, and a carrier medium or storage medium.

The above described example embodiments can be applied to an image forming apparatus such as printers, copiers, multi-functional apparatuses using electrophotography for forming and fixing an image using a fixing unit, an image forming control method, an image forming control program, and a carrier medium.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined with each other and/or substituted for each other within the scope of this disclosure and appended claims.

What is claimed is:

1. An image forming apparatus, comprising:
an image drawing data generator to generate image drawing data including text and/or photo information, page by page, from image data to be printed by the image forming apparatus;
an image forming unit to form a latent image on a photoconductor based on the image drawing data, develop the latent image developed with a developer agent, and transfer the developed image onto a recording medium;
a fixing unit to fix the developed image on the recording medium by applying heat to the recording medium, the fixing unit including a fixing device having a plurality of heaters, a surface of the fixing device being segmented into a plurality of heating areas each corresponding to a respective one of the plurality of heaters, each of the heating areas heatable to a given control-target fixing temperature independently settable for each of the heating areas;
a fixing temperature setting unit to set the control-target fixing temperature independently at each of the heating areas of the fixing device by associating the text and/or photo information in the image drawing data, generated by the image drawing data generator with the position of each of the heating areas; and
a heating control unit to control current supply to each of the heaters based on the control-target fixing temperature set at each of the heating areas by the fixing temperature setting unit, by which each of the heating areas is heated to the set control-target fixing temperature.

2. The image forming apparatus of claim 1, wherein the surface of the fixing device is segmented into the plurality of heating areas at least axially along the heater or in a direction perpendicular to the axis of the heater.

3. The image forming apparatus of claim 1, wherein the fixing temperature setting unit sets image areas of the image drawing data corresponding to the heating areas of the fixing device based on coordinates of each piece of image data.

4. The image forming apparatus of claim 1, wherein the fixing temperature setting unit further comprises a control-target fixing temperature table that sets control-target fixing temperature for each piece of image data including text and/or photo information, and the fixing temperature setting unit determines the control-target fixing temperature for each of the heating areas based on the text and/or photo information included in the image drawing data by referring to the control-target fixing temperature table set for the text and photo information.

5. A method of controlling image formation by an image forming apparatus, comprising the steps of:
generating image drawing data including text and/or photo information, page by page, from image data to be printed by the image forming apparatus;
forming a latent image on a photoconductor based on the image drawing data;
developing the latent image with a developer agent;
transferring the developed image onto a recording medium;
fixing the developed image on the recording medium by applying heat to the recording medium, using a fixing unit including a fixing device having a plurality of heaters, a surface of the fixing device being segmented into a plurality of heating areas each corresponding to a respective one of the plurality of heaters, each of the heating areas heatable to a given control-target fixing temperature independently settable for each of the heating areas;
setting the control-target fixing temperature independently at each of the heating areas of the fixing device by associating the text and photo information in the image drawing data generated at the generating step with the position of each of the heating areas; and
controlling current supply to each of the heating areas of the heater based on the control-target fixing temperature set at each of the heating areas by the setting step, by which each of the heating areas is heated to the set control-target fixing temperature.

6. A non-transitory computer readable carrier medium storing a program for executing a method of controlling image formation by an image forming apparatus, which when executed causes a computer to perform the method of controlling image formation, the method comprising the steps of:
generating image drawing data including text and/or photo information, page by page, from image data to be printed by the image forming apparatus;
forming a latent image on a photoconductor based on the image drawing data;
developing the latent image with a developer agent;
transferring the developed image onto a recording medium;
fixing the developed image on the recording medium by applying heat to the recording medium, using a fixing unit including a fixing device having a plurality of heaters, a surface of the fixing device being segmented into a plurality of heating areas each corresponding to a respective one of the plurality of heaters, each of the heating areas heatable to a given control-target fixing temperature independently settable for each of the heating areas;
setting the control-target fixing temperature independently at each of the heating areas of the fixing device by associating the text and photo information in the image drawing data generated at the generating step with the position of each of the heating areas; and
controlling current supply to each of the heating areas of the heater based on the control-target fixing temperature set at each of the heating areas by the setting step, by which each of the heating areas is heated to the set control-target fixing temperature.
